(19) United States
(12) Patent Application Publication
(10) Pub. No.: US 2016/0180382 A1
(43) Pub. Date: Jun. 23, 2016

(54) SYSTEM AND METHOD FOR IMPROVED SERVER PERFORMANCE

(71) Applicant: YAHOO! INC., Sunnyvale, CA (US)

(72) Inventors: Varun Bhagwan, San Jose, CA (US); Doug Sharp, San Francisco, CA (US); Jaikit Savla, Santa Clara, CA (US); Rahul Teotia, Sunnyvale, CA (US); Jac Wang, San Jose, CA (US); Deepak Agarwal, Milpitas, CA (US); Jesper Anderson, Oakland, CA (US)

(21) Appl. No.: 14/579,444

(22) Filed: Dec. 22, 2014

(51) Int. Cl. G06Q 30/02

(52) U.S. Cl. CPC G06Q 30/0255

(57) ABSTRACT

Disclosed are systems and methods for improving interactions between servers in a messaging system supported by or configured with advertising servers or platforms. The systems interact to filter data across platforms, which data can be used to improve the contextual quality of data used in processing interactions between or among processors in such systems.

This application includes material that is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The present disclosure relates generally to improving the performance of server systems and/or platforms programmed to work in concert with messaging systems to serve advertisements.

### RELATED ART

Marketing of products and services online through advertisements is ubiquitous across all Internet platforms. Internet advertising via ad servers has proven to be an effective and lucrative source of revenue. Advertising on the Internet provides the possibility of allowing advertisers to cost-effectively reach highly specific target audiences—as opposed to traditional broadcast and print advertising media that reach only broadly definable target audiences (e.g. television viewers in the greater New York area).

### SUMMARY

The present disclosure describes computer systems and methods for targeting a user with advertisements and/or other types of promotional information by leveraging prior purchase information derived from a user's purchase activity. That is, according to embodiments of the present disclosure, the disclosed systems and methods can analyze a user's inbox for purchase receipt messages (e.g., order confirmation messages) in order to identify information related to prior and/or recent purchases the user has made. Such information can include, but is not limited to, the item purchased (e.g., a product or service) and the seller or vendor's information. Based on this information, selected advertisements that are to be served to a user are selected in a manner that avoids duplicating promotional material associated with the prior or recent purchase from the same vendor. In some embodiments, advertisements corresponding to a prior or recent purchase may be served to the user when the ads are associated with a different vendor from the vendor that previously sold the item to the user. In some embodiments, such ads being served from alternative vendors may only be served when such vendors are offering promotions associated with the purchased item at a lower price.

According to embodiments of the present disclosure, the disclosed systems and methods ensure that a user is not receiving promotional information (e.g., advertisements or coupons) for items that the user has already purchased. According to embodiments of the present disclosure, systems and methods are also disclosed where promotional information can be provided to a user despite the information being associated with an item recently purchased, but only when the promotional information is being sourced from, or associated with a different vendor than the vendor that recently sold the user the item. The disclosed systems and methods prevent served promotional information from wasting valuable ad impressions, thereby freeing ad-space “real-estate” to be used in a manner that will increase monetization through higher click-through-rates (CTRs) and increased return-on-investment (ROI), revenues, salience and relevance of served advertisements.

In accordance with one or more embodiments, a method is disclosed which includes accessing, via a computing device, a user inbox hosted by the computing device on a network; analyzing, via the computing device, using an automated data mining and parsing process, messages in the inbox to identify a first message, the analyzing comprising the computing device parsing message data associated with the first message; determining as part of the analysis, via the computing device, that at least a portion of the message data is associated with purchase information, the purchase information comprising information related to a purchased item and a vendor from which the item was purchased; creating, via the computing device and based on the determining, a filter rule comprising instructions to filter out content related to the purchased item from the vendor; communicating with a content platform (e.g., ad platform), via the computing device over the network, to obtain a content item satisfying the filter rule; and causing communication, via the computing device over the network, of the rule satisfying content item to the user.

In accordance with one or more embodiments, the disclosed method further includes creating, via the computing device, a second filter rule comprising instructions to identify content related to the purchased item from a second vendor, the second vendor being a different vendor than the vendor identified in the purchase information; communicating with the content platform, via the computing device over the network, to obtain a second content item satisfying the second filter rule; and causing communication, via the computing device over the network, of the second rule satisfying content item to the user.

In accordance with one or more embodiments, a non-transitory computer-readable storage medium is provided, the computer-readable storage medium tangibly storing thereon, or having tangibly encoded thereon, computer readable instructions that when executed cause at least one processor to perform a method for leveraging prior purchases when serving advertisements.

In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code to implement functionality in accordance with one or more such embodiments is embodied in, by and/or on a non-transitory computer-readable medium.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a schematic diagram illustrating an example of a network within which the systems and methods disclosed herein could be implemented according to some embodiments of the present disclosure;

FIG. 2 depicts is a schematic diagram illustrating a client device in accordance with some embodiments of the present disclosure;

FIG. 3 is a schematic block diagram illustrating components of a system in accordance with embodiments of the present disclosure;

FIG. 4 is a flowchart illustrating steps performed in accordance with some embodiments of the present disclosure; and

FIG. 5 is a block diagram illustrating architecture of a hardware device in accordance with one or more embodiments of the present disclosure.

### DESCRIPTION OF EMBODIMENTS

The present disclosure will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer, special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

These computer program instructions can be provided to a processor of a general purpose computer, special purpose computer, ASIC, or other programmable data processing apparatus, such that the instructions, which execute via the processor of the computer or other programmable data processing apparatus, implement the functions/acts specified in the block diagrams or operational block or blocks.

For the purposes of this disclosure a computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

For purposes of this disclosure, a client (or consumer or user) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device an Near Field Communication (NFC) device, a Personal Digital Assistant (PDA), a handheld computer, a tablet computer, a laptop computer, a set top box, a wearable computer, an integrated device combining various features, such as features of the forgoing devices, or the like.

A client device may vary in terms of capabilities or features. Claimed subject matter is intended to cover a wide range of potential variations. For example, a cell phone may include a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

A client device may include or may execute a variety of operating systems, including a personal computer operating system, such as a Windows, iOS or Linux, or a mobile operating system, such as iOS, Android, or Windows Mobile, or the like. A client device may include or may execute a variety of possible applications, such as a client software application enabling communication with other devices, such as communicating one or more messages, such as via email, short message service (SMS), or multimedia message service (MMS), including via a network, such as a social network, including, for example, Facebook®, LinkedIn®, Twitter®, Flickr®, or Google+®, Instagram™, to provide only a few possible examples. A client device may also include or execute an application to communicate content, such as, for example, textual content, multimedia content, or the like. A client device may also include or execute an application to perform a variety of possible tasks, such as browsing, searching, playing various forms of content, including locally stored or streamed video, or games (such as fantasy sports leagues). The foregoing is provided to illustrate that claimed subject matter is intended to include a wide range of possible features or capabilities.

The principles described herein may be embodied in many different forms. By way of background, conventional advertising systems focus on serving advertisements by using the marketing tool known as “retargeting.” As understood by those of skill in the art, retargeting is performed by displaying ads to a user as they browse the internet by marking or tagging online users who visit a certain brand website with a “burn pixel,” “frequency cap” or a cookie. Such marking or tagging enables ad systems to serve ads to the people who have shown at least some amount of engagement in a brand. Such ad systems base the ads that are being served on an interest the user has previously expressed.

Conventional ad systems attempt to discern a user's intent or interest when determining which advertisements to serve to the user; however, often times such advertisements are based on old or stale information resulting in duplicate or wasteful promotions being shown to the user. The disclosed systems and methods remedy the shortcomings evident in currently applied targeting ad systems by leveraging prior purchase information derived from a user's purchase activity. Serving or displaying ads for products the user has already purchased not only annoys users but also leads to a poor customer experience. By utilizing the disclosed systems and methods' real-time visibility to product purchases, the present disclosure provides effective ways to prevent wasteful ad impressions resultant from retargeting users with information similar to products/services the users have already purchased. Indeed, instead of relying a on a cookie, burn pixel or frequency cap for retargeting, the present disclosure allows time-boxing particular retargeting campaigns to, for example, stop retargeting for product for a period of time.

According to embodiments of the present disclosure, the disclosed systems and methods can analyze a user's inbox for purchase receipt messages (e.g., order confirmation messages) in order to identify information related to prior and/or recent purchases the user has made. Such information can include, but is not limited to, the item purchased (e.g., a product or service) and the seller or vendor's information. Based on this information, selected content, generally in the form of promotional material or advertisements that are to be served to a user, is selected in a manner that avoids duplicating promotional material associated with the prior or recent purchase from the same vendor. In some embodiments, advertisements corresponding to a prior or recent purchase may be served to the user when the ads are associated with a different vendor from the vendor that previously sold the user the item. In some embodiments, such ads being served from alternative vendors may only be served when such vendors are offering promotions associated with the purchased item at a lower price.

According to embodiments of the present disclosure, the disclosed systems and methods ensure that a user is not receiving content, generally in the form of promotional information (e.g., advertisements or coupons) for items that the user has already purchased. According to embodiments of the present disclosure, content, such as for example promotional information can be provided to a user despite the information being associated with an item recently purchased, but only when the promotional information is being sourced from, or associated with a different vendor than the vendor that recently sold the user the item. The disclosed systems and methods prevent served promotional information from wasting valuable ad impressions, thereby freeing ad-space “real-estate” to be used in a manner that will increase monetization through higher click-through-rates (CTRs) and increased return-on-investment (ROI), revenues, salience and relevance of served advertisements.

For example, in accordance with conventional retargeting ad systems, if a user visited a site before purchasing a product, the user will be retargeted by all remaining product vendors with advertisements associated with the product the user already purchased. The disclosed systems and methods can leverage a user's purchase history to inform product vendors to stop retargeting the user with ads for the same product. Thus, based on the present disclosure, available ad space can now be used for showing different promotional information to the user thereby improving user experience and increasing monetization opportunities.

Websites, messaging applications and other platforms that host and/or serve advertisements are typically paid on a cost per impression basis (CPM), a cost per click (CPC), or cost per action accomplished (CPA), or under some other agreed upon billable event. Through implementation of the disclosed systems and methods, such hosting platforms, in addition to the sponsored advertisers can benefit from improved sales due to increased billable events being realized as the disclosed systems and methods ensure that advertisements being served to users are contextually relevant and not duplicates of previous advertisements or purchases.

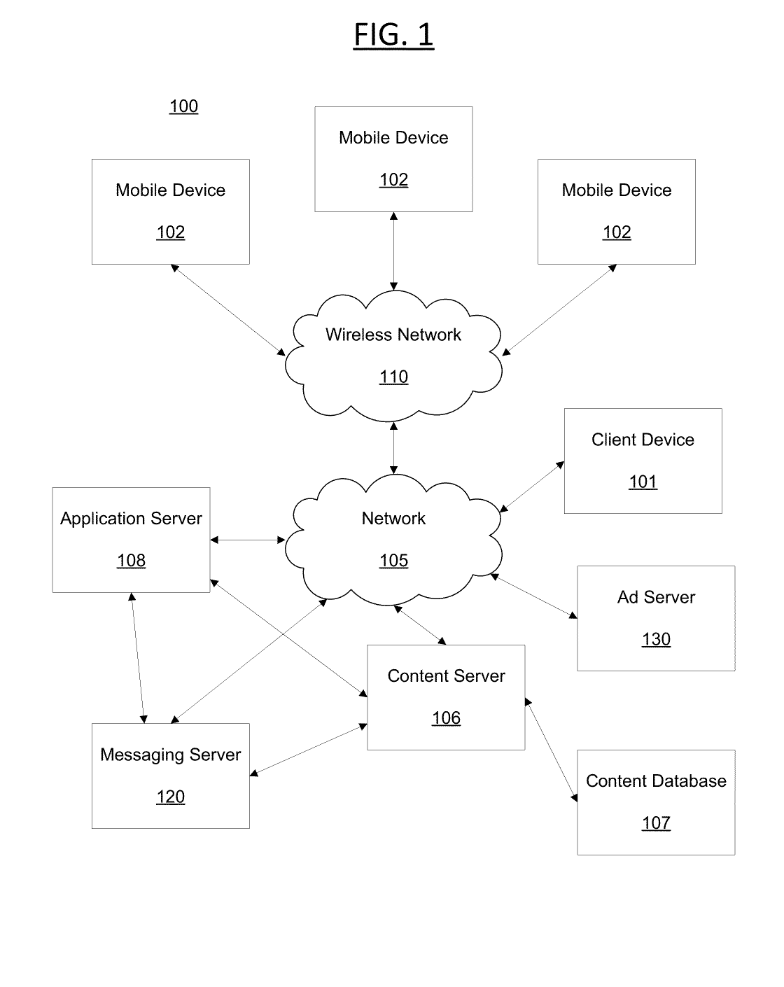

Certain embodiments will now be described in greater detail with reference to the figures. In general, with reference to FIG. 1, a system 100 in accordance with an embodiment of the present disclosure is shown. FIG. 1 shows components of a general environment in which the systems and methods discussed herein may be practiced. Not all the components may be required to practice the disclosure, and variations in the arrangement and type of the components may be made without departing from the spirit or scope of the disclosure. As shown, system 100 of FIG. 1 includes local area networks (“LANs”)/wide area networks (“WANs”)—network 105, wireless network 110, mobile devices (client devices) 102 and client device 101. FIG. 1 additionally includes a variety of servers, such as content server 106, application (or “App”) server 108, messaging server 120 and advertising (“ad”) server 130.

One embodiment of mobile devices 102-103 is described in more detail below. Generally, however, mobile devices 102 may include virtually any portable computing device capable of receiving and sending a message over a network, such as network 105, wireless network 110, or the like. Mobile devices 102 may also be described generally as client devices that are configured to be portable. Thus, mobile devices 102 may include virtually any portable computing device capable of connecting to another computing device and receiving information. Such devices include multi-touch and portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, and the like. As such, mobile devices 102 typically range widely in terms of capabilities and features. For example, a cell phone may have a numeric keypad and a few lines of monochrome LCD display on which only text may be displayed. In another example, a web-enabled mobile device may have a touch sensitive screen, a stylus, and several lines of color LCD display in which both text and graphics may be displayed.

A web-enabled mobile device may include a browser application that is configured to receive and to send web pages, web-based messages, and the like. The browser application may be configured to receive and display graphics, text, multimedia, and the like, employing virtually any web based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message.

Mobile devices 102 also may include at least one client application that is configured to receive content from another computing device. The client application may include a capability to provide and receive textual content, graphical content, audio content, and the like. The client application may further provide information that identifies itself, including a type, capability, name, and the like. In one embodiment, mobile devices 102 may uniquely identify themselves through any of a variety of mechanisms, including a phone number, Mobile Identification Number (MIN), an electronic serial number (ESN), or other mobile device identifier.

In some embodiments, mobile devices 102 may also communicate with non-mobile client devices, such as client device 101, or the like. In one embodiment, such communications may include sending and/or receiving messages, share photographs, audio clips, video clips, or any of a variety of other forms of communications. Client device 101 may include virtually any computing device capable of communicating over a network to send and receive information. The set of such devices may include devices that typically connect using a wired or wireless communications medium such as personal computers, multiprocessor systems, microprocessor-based or programmable consumer electronics, network PCs, or the like. Thus, client device 101 may also have differing capabilities for displaying navigable views of information.

Client devices 101-102 computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Wireless network 110 is configured to couple mobile devices 102 and its components with network 105. Wireless network 110 may include any of a variety of wireless sub-networks that may further overlay stand-alone ad-hoc networks, and the like, to provide an infrastructure-oriented connection for mobile devices 102. Such sub-networks may include mesh networks, Wireless LAN (WLAN) networks, cellular networks, and the like.

Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly. Wireless network 110 may further employ a plurality of access technologies including 2nd (2G), 3rd (3G), and/or 4th (4G) generation radio access for cellular systems, WLAN, Wireless Router (WR) mesh, and the like. Access technologies such as 2G, 3G, 4G and future access networks may enable wide area coverage for mobile devices, such as mobile devices 102 with various degrees of mobility. For example, wireless network 110 may enable a radio connection through a radio network access such as Global System for Mobil communication (GSM), General Packet Radio Services (GPRS), Enhanced Data GSM Environment (EDGE), Wideband Code Division Multiple Access (WCDMA), and the like. In essence, wireless network 110 may include virtually any wireless communication mechanism by which information may travel between mobile device s 102 and another computing device, network, and the like.

Network 105 is configured to couple content server 106, application server 108, or the like, with other computing devices, including, client device 101, and through wireless network 110 to mobile devices 102. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between content servers 106, application server 108, client device 101, and/or other computing devices.

Within the communications networks utilized or understood to be applicable to the present disclosure, such networks will employ various protocols that are used for communication over the network. Signal packets communicated via a network, such as a network of participating digital communication networks, may be compatible with or compliant with one or more protocols. Signaling formats or protocols employed may include, for example, TCP/IP, UDP, DECnet, NetBEUI, IPX, APPLETALK™, or the like. Versions of the Internet Protocol (IP) may include IPv4 or IPv6. The Internet refers to a decentralized global network of networks. The Internet includes local area networks (LANs), wide area networks (WANs), wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

According to some embodiments, the present disclosure may also be utilized within a social networking site. A social network refers generally to a network of individuals, such as acquaintances, friends, family, colleagues, or co-workers, coupled via a communications network or via a variety of sub-networks. Potentially, additional relationships may subsequently be formed as a result of social interaction via the communications network or sub-networks. In some embodiments, multi-modal communications may occur between members of the social network. Individuals within one or more social networks may interact or communication with other members of a social network via a variety of devices. Multi-modal communication technologies refers to a set of technologies that permit interoperable communication across multiple devices or platforms, such as cell phones, smart phones, tablet computing devices, personal computers, televisions, set-top boxes, SMS/MMS, email, instant messenger clients, forums, social networking sites, or the like.

In some embodiments, the disclosed networks 110 and/or 105 may comprise a content distribution network(s). A “content delivery network” or “content distribution network” (CDN) generally refers to a distributed content delivery system that comprises a collection of computers or computing devices linked by a network or networks. A CDN may employ software, systems, protocols or techniques to facilitate various services, such as storage, caching, communication of content, or streaming media or applications. A CDN may also enable an entity to operate or manage another's site infrastructure, in whole or in part.

The content server 106 may include a device that includes a configuration to provide content via a network to another device. A content server 106 may, for example, host a site, such as an email platform or social networking site, or a personal user site (such as a blog, vlog, online dating site, and the like). A content server 106 may also host a variety of other sites, including, but not limited to business sites, educational sites, dictionary sites, encyclopedia sites, wikis, financial sites, government sites, and the like. Devices that may operate as content server 106 include personal computers desktop computers, multiprocessor systems, microprocessor-based or programmable consumer electronics, network PCs, servers, and the like.

Content server 106 can further provide a variety of services that include, but are not limited to, email services, photo services, web services, third-party services, audio services, video services, instant messaging (IM) services, SMS services, MMS services, FTP services, voice over IP (VOIP) services, or the like. Such services, for example the email services and email platform, can be provided via the messaging server 120. Examples of content may include images, text, audio, video, or the like, which may be processed in the form of physical signals, such as electrical signals, for example, or may be stored in memory, as physical states, for example.

An ad server 130 comprises a server that stores online advertisements for presentation to users. “Ad serving” refers to methods used to place online advertisements on websites, in applications, or other places where users are more likely to see them, such as during an online session or during computing platform use, for example. Various monetization techniques or models may be used in connection with sponsored advertising, including advertising associated with user. Such sponsored advertising includes monetization techniques including sponsored search advertising, non-sponsored search advertising, guaranteed and non-guaranteed delivery advertising, ad networks/exchanges, ad targeting, ad serving and ad analytics.

For example, a process of buying or selling online advertisements may involve a number of different entities, including advertisers, publishers, agencies, networks, or developers. To simplify this process, organization systems called “ad exchanges” may associate advertisers or publishers, such as via a platform to facilitate buying or selling of online advertisement inventory from multiple ad networks. “Ad networks” refers to aggregation of ad space supply from publishers, such as for provision en masse to advertisers. For web portals like Yahoo!®, advertisements may be displayed on web pages resulting from a user-defined search based at least in part upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users. One approach to presenting targeted advertisements includes employing demographic characteristics (e.g., age, income, sex, occupation, etc.) for predicting user behavior, such as by group. Advertisements may be presented to users in a targeted audience based at least in part upon predicted user behavior(s).

Another approach includes profile-type ad targeting. In this approach, user profiles specific to a user may be generated to model user behavior, for example, by tracking a user's path through a web site or network of sites, and compiling a profile based at least in part on pages or advertisements ultimately delivered. A correlation may be identified, such as for user purchases, for example. An identified correlation may be used to target potential purchasers by targeting content or advertisements to particular users. During presentation of advertisements, a presentation system may collect descriptive content about types of advertisements presented to users. A broad range of descriptive content may be gathered, including content specific to an advertising presentation system. Advertising analytics gathered may be transmitted to locations remote to an advertising presentation system for storage or for further evaluation. Where advertising analytics transmittal is not immediately available, gathered advertising analytics may be stored by an advertising presentation system until transmittal of those advertising analytics becomes available.

Servers 106, 108, 120 and 130 may be capable of sending or receiving signals, such as via a wired or wireless network, or may be capable of processing or storing signals, such as in memory as physical memory states. Devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally, a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

In some embodiments, users are able to access services provided by servers 106, 108, 120 and/or 130. This may include in a non-limiting example, email servers, social networking services servers, SMS servers, IM servers, MMS servers, exchange servers, photo-sharing services servers, and travel services servers, via the network 105 using their various devices 101-102. In some embodiments, applications, such as a messaging application (e.g., Yahoo! Messenger®, Yahoo! Mail®, and the like), can be hosted by the application server 108. Thus, the application server 108 can store various types of applications and application related information including application data and user profile information. In another example, messaging server 120 can host email applications; therefore, the messaging server 120 can store various types of applications and application related information including email application data and user profile information. It should also be understood that content server 106 can also store various types of data related to the content and services provided by content server 106 in an associated content database 107, as discussed in more detail below. Embodiments exist where the network 105 is also coupled with/connected to a Trusted Search Server (TSS) which can be utilized to render content in accordance with the embodiments discussed herein.

Moreover, although FIG. 1 illustrates servers 106, 108, 120 and 130 as single computing devices, respectively, the disclosure is not so limited. For example, one or more functions of servers 106, 108, 120 and/or 130 may be distributed across one or more distinct computing devices. Moreover, in one embodiment, servers 106, 108, 120 and/or 130 may be integrated into a single computing device, without departing from the scope of the present disclosure.

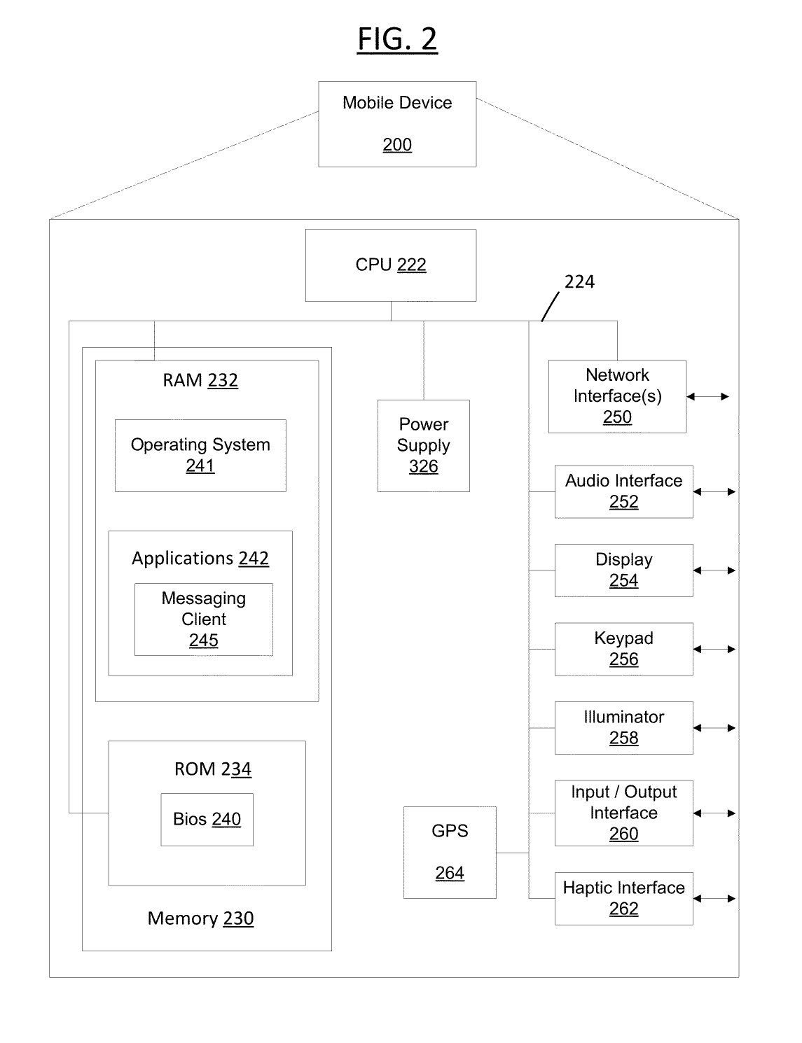

FIG. 2 is a schematic diagram illustrating a client device showing an example embodiment of a client device that may be used within the present disclosure. Client device 200 may include many more or less components than those shown in FIG. 2. However, the components shown are sufficient to disclose an illustrative embodiment for implementing the present disclosure. Client device 200 may represent, for example, client devices discussed above in relation to FIG. 1.

As shown in the figure, Client device 200 includes a processing unit (CPU) 222 in communication with a mass memory 230 via a bus 224. Client device 200 also includes a power supply 226, one or more network interfaces 250, an audio interface 252, a display 254, a keypad 256, an illuminator 258, an input/output interface 260, a haptic interface 262, and an optional global positioning systems (GPS) receiver 264. Power supply 226 provides power to Client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling Client device 200 to one or more networks, and is constructed for use with one or more communication protocols and technologies including, but not limited to, global system for Client communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Haptic interface 262 is arranged to provide tactile feedback to a user of the client device. For example, the haptic interface may be employed to vibrate client device 200 in a particular way when the Client device 200 receives a communication from another user.

Optional GPS transceiver 264 can determine the physical coordinates of Client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of Client device 200 on the surface of the Earth. It is understood that under different conditions, GPS transceiver 264 can determine a physical location within millimeters for Client device 200; and in other cases, the determined physical location may be less precise, such as within a meter or significantly greater distances. In one embodiment, however, Client device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of Client device 200. The mass memory also stores an operating system 241 for controlling the operation of Client device 200. It will be appreciated that this component may include a general purpose operating system such as a version of UNIX, or LINUX™, or a specialized client communication operating system such as Windows Client™, or the Symbian® operating system. The operating system may include, or interface with a Java virtual machine module that enables control of hardware components and/or operating system operations via Java application programs.

Memory 230 further includes one or more data stores, which can be utilized by Client device 200 to store, among other things, applications 242 and/or other data. For example, data stores may be employed to store information that describes various capabilities of Client device 200. The information may then be provided to another device based on any of a variety of events, including being sent as part of a header during a communication, sent upon request, or the like. At least a portion of the capability information may also be stored on a disk drive or other storage medium (not shown) within Client device 300.

Applications 242 may include computer executable instructions which, when executed by Client device 200, transmit, receive, and/or otherwise process audio, video, images, and enable telecommunication with another user of another client device. Other examples of application programs include calendars, browsers, contact managers, task managers, transcoders, database programs, word processing programs, security applications, spreadsheet programs, games, search programs, and so forth. Applications 242 may further include messaging client 245 that is configured to send, to receive, and/or to otherwise process messages using email, SMS, MMS, IM, VOIP, and/or any of a variety of other messaging communication protocols. Although a single messaging client 245 is illustrated it should be clear that multiple messaging clients may be employed. For example, one messaging client may be configured to manage email messages, where another messaging client manages SMS messages, and yet another messaging client is configured to manage serving advertisements, IMs, or the like.

Having described the components of the general architecture employed within the disclosed systems and methods, the components' general operation with respect to the disclosed systems and methods will now be described.

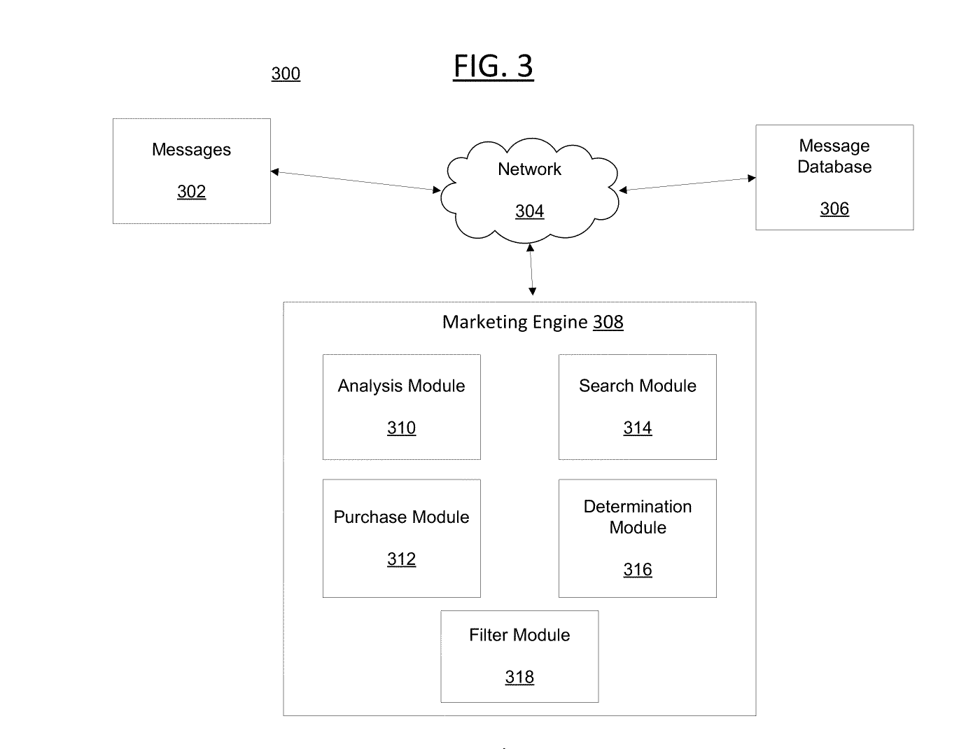

FIG. 3 is a block diagram illustrating the components of system 300 for performing the systems and methods discussed herein. FIG. 3 includes a plurality of messages 302, a network 304, a marketing engine 308 and a database 306 for storing messages. The marketing engine 308 could be hosted by a web server, content provider, email service provider, ad server, a user's computing device, or any combination thereof. The plurality of messages 302 can be any type of message. Examples of such messages 302 can include email messages, HTML forms SMS/MMS messages, Skype® messages, Twitter® messages and other social messages, comments to an article or website, online forum posts/entries, word processing documents, help desk messages, portable document format (PDF) documents and/or other types of documents. The messages 302 can be provided to the marketing engine 308 or accessed by a computer program or device that can access the messages. In some embodiments, the messages 302 can be stored in a database of stored messages 306, which is associated with an email provider, such as Yahoo! Mail®. The database 306 can be any type of database or memory that can store the messages 302 and associated message template information, as discussed above.

For purposes of the present disclosure, email messages as a whole are discussed within some embodiments; however, it should not be construed to limit the applications of the systems and methods discussed herein. Indeed, while reference is made throughout the instant disclosure to email messages, other forms of electronic documents or transmissions (e.g., Short Message Service (SMS) messages, Multi-media Message Service (MMS) messages, and the like) can be communicated and/or accessed and processed by the marketing engine 308 according to the systems and methods discussed herein.

As discussed above, with reference to FIG. 1, the network 304 can be any type of network such as, but not limited to, a wireless network, a local area network (LAN), wide area network (WAN), the Internet, or a combination thereof. The network 304 facilitates connectivity between the messages 302, the marketing engine 308, and the database of stored resources 306.

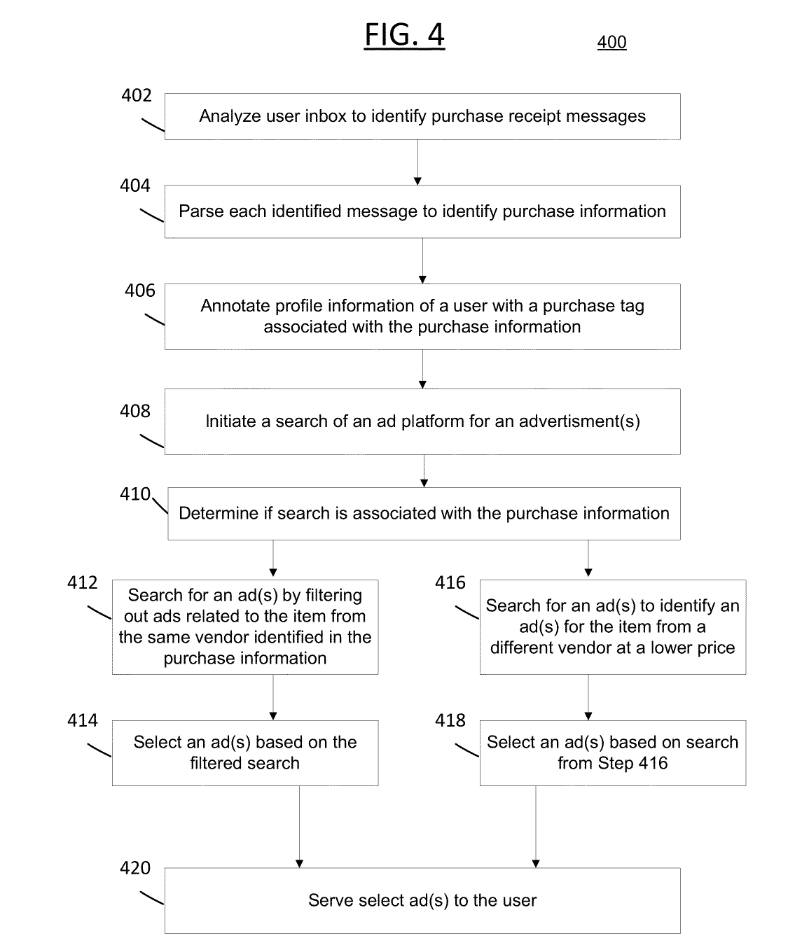

The principal processor, server, or combination of devices that comprises hardware programmed in accordance with the special purpose functions herein, referred to for convenience as marketing engine 308, includes an analysis module 310, a purchase module 312, a search module 314, a determination module 316 and a filter module 318. It should be understood that the engine(s) and modules discussed herein are non-exhaustive, as additional or fewer engines and/or modules may be applicable to the embodiments of the systems and methods discussed. The operations, configurations and functionalities of each module, and their role within embodiments of the present disclosure will be discussed with reference to FIG. 4.

FIG. 4 is a process 400 diagram illustrating steps performed in accordance with embodiments of the present disclosure for leveraging prior purchase information derived from a user's purchase activity in order to provide content, generally in the form of advertisements to the user while avoiding serving duplicative promotional information to the user. Process 400, which is performed by the marketing engine 308, involves analyzing a user's inbox for purchase receipt messages (e.g., order confirmation messages) in order to identify information related to prior and/or recent purchases the user has made.

Such information can include, but is not limited to, the item purchased (e.g., a product or service) and the seller or vendor's information. Based on this information, selected advertisements that are to be served to a user are selected in a manner that avoids duplicating promotional material associated with the prior or recent purchase from the same vendor. In some embodiments of Process 400, advertisements corresponding to a prior or recent purchase may be served to the user when the ads are associated with a different vendor from the vendor that previously sold the user the item. In some embodiments, such ads being served from alternative vendors may only be served when such vendors are offering promotions associated with the purchased item at a lower price.

According to some embodiments, the disclosed marketing systems and methods discussed herein can be per user or an aggregate of users. For purposes of this disclosure, the focus will be on serving ads and/or content to a single user; however, it should not be construed as limiting, as the systems and methods discussed herein are applicable to a plurality or group of users, as Process 400 is applicable to not only a plurality of users analyzed individually, but also to a plurality of users analyzed as an aggregate.

In some embodiments, the disclosed systems and methods can be performed from (or within) a single message platform, e.g., Yahoo! Mail®; and in some embodiments, the across multiple platforms, such as Yahoo! Mail®, Google Mail®, Hotmail®, and other personal and business email platforms, such as Microsoft Outlook®, and the like. In some embodiments, at least some steps performed in Process 400 of FIG. 4 can be performed offline and/or online, as discussed in more detail below.

Process 400 beings within Step 402 where a user's inbox(es) is/are analyzed to identify purchase receipt messages. This step is performed by the analysis module 310 of the marketing engine 308. In some embodiments, Step 402 involves mining the entire inbox of the user, including all sub-folders and categorized messages. Such mining enables the identification of messages that correspond to purchase receipt messages. It should be understood that the analysis and mining occurring in Step 402 can be performed in accordance with any known or to be known data mining or machine learning algorithm or technique, such as but not limited to, Sparse Factor Analysis (SFA), Hidden Markov Models (HMMs), Support Vector Machines (SVMs), Bayesian Methods, and the like.

As discussed herein, purchase receipt messages (e.g., order confirmation messages or delivery confirmation messages) are those messages that a user receives as receipt and/or confirmation of a purchase. For example, if a user purchases a bicycle on Amazon®, the user will receive a purchase receipt message detailing the purchase. Typically, such receipt message will include information related to, but not limited to, the vendor (e.g., seller), the purchaser, the item purchased, the amount paid, and the purchase date, and the like. Therefore, as discussed in more detail below in relation to the steps of Process 400, the analysis module 310 can mine a user's inbox in order to identify received purchase receipt messages comprising purchase information.

In Step 404 each identified purchase receipt message is parsed to identify purchase receipt information comprised within each message. Step 404 is also performed by the analysis module 310. Step 404 involves parsing each identified purchase receipt message and/or associated message metadata to identify information related to the purchased item and the vendor (or seller) information, and/or the purchase date (e.g., when the item was purchased or when the item will be delivered or is available, or if the item is a service, when the service is available to the user). As discussed above the purchased item can be a product or service purchased by the user; therefore the item information can include the name of the purchased product or service. The vendor information can include the seller's identity, such as the same of the seller, or an email address associated with the seller. The parsing occurring in Step 404 can include parsing each message and/or message metadata, including but not limited to, the subject line, sender identifier (from the “From:” section of the message) and body of the message.

By way of a non-limiting example, user Bob's inbox is analyzed and a purchase receipt message is identified for Bob's recent purchase of a ski jacket from the Gap®. The purchase receipt information reveals that Bob purchased the ski jacket on Nov. 15, 2014, and the Gap® information is determined by the message comprising information indicating the Gap® as the seller. As discussed above, the seller information can be determined based on information included in the message, or from metadata associated with the message. For example, the purchase receipt message (or order confirmation message) was sent from orders@gap.com. Therefore, it can readily be determined by parsing the message information that the Gap® retail store is the seller.

In some embodiments, Steps 402 and Step 404 can be performed as a single step where the parsing of the purchase receipt messages performed by the analysis module 310 occurs upon identification of each purchase receipt message. In some embodiments, in order to identify a purchase receipt message, as in Step 402, the parsing Step 404 can be used to identify such messages. As such, the analysis occurring in Steps 402 and 404 can include identifying messages and/or associated message metadata that include information related to a purchased item, a vendor's identity and/or a purchase date (in the message metadata, message body, subject line or in the sender identifier, or some combination thereof).

In some embodiments, the identification occurring in Step 404 can include a determination regarding a category associated with the item identified in the purchase receipt. As understood by those of skill in the art, a category refers to a predetermined range of items a purchased item falls within or is associated with. A category can be associated with a specific vendor or multiple vendors. For example, a user has purchase receipts in his/her inbox associated with a car purchase, a silverware purchase and a cruise purchase. As such, the car purchase can be determined to be associated with a “vehicle” category, the silverware purchase can be determined to be associated with a “kitchen” category, and the cruise purchase can be associated with a “vacation” category. As discussed below, the category determination can be utilized in filtering, selecting and serving advertisements.

For example, continuing with the example of Bob's purchase of a ski jacket from the Gap®, a determination can be from the identification that the item was a ski jacket that Bob purchased an item categorized as a “winter jacket.” As will be seen from the below discussion, this information can be used to avoid sending Bob content or promotional information related to purchasing another winter jacket.

By way of another example, a category of an item may be based on the identity of the sender. That is, if Bob purchased a Lego® set from Toys R' Us®, it can be determined that the item Bob purchased relates to a “toy” category, as such vendor focuses upon selling toys for children.

In Step 406, a profile associated with the user is annotated with the purchase information. In some embodiments, the annotation can comprise a tag that indicates the purchase information determined from Step 404. In some embodiments, the profile associated with the user is a user profile specific to the user, and in some embodiments the profile is a platform spanning profile that includes purchase information cataloging purchase histories of a plurality of users. In some embodiments, the tag can denote a “blacklist” of users/items and/or vendors. This “blacklist” can provide information to an ad platform indicating that the user should not be served ads for items and/or from vendors identified in the listing, as discussed in more detail below. Step 406 is performed by the purchase module 312 of the marketing engine 308.

According to some embodiments, the annotation occurring in Step 406 may not be an annotation to a profile, but may actually be an entry into a purchase history container (specific to the user) within a database. In conjunction with the above discussion, the entry can provide information to an ad platform intercommunicating with or integrated with the messaging platform indicating that the user should not be served ads for items and/or from vendors identified in the listing, as discussed in more detail below.

According to some embodiments, the purchase information can be utilized to create a filter rule that is associated with the user or user's profile, As discussed below in relation to Steps 412-4418, the filter rule(s) can include instructions for filtering out and/or identifying ads comprising particular content according to the ad content's similarity to the purchased item, vendor identity and purchase price, or some combination thereof.

For purposes of this disclosure, the purchase information and filter rule being associated with the user's profile will be referred to as a “purchase tag;” however, it should not be construed as limited to solely a tag's implementation as understood by those of skill in the art, as the above embodiments discussed above, for example, the database entry, purchase history cataloging and/or “blacklist” are intended to be included in such disclosure related to the purchase tag discussion and implementation below.

According to some embodiments, the purchase tag may only be active, or associated with a user profile (or user name, or other information identifying the user on a website or across a website, such as, for example, an IP address) for a limited period of time. That is, a time window may govern the lifespan of the purchase tag. This ensures that the purchase tag expires at some point in the future thereby enabling the user to receive ads from the same vendor and the same product. In some embodiments the time window may be based on the item, category of the item, the purchase history of the recipient, the seller, or some combination thereof. In some embodiments, for example, it can be determined that a user purchased the item on day X, then 2 weeks later purchased the item again. This determination can serve as a basis for the timing window which can reflect that the user does not need the item for at least 2 weeks from receiving the item.

By way of example, solely to illustrate the determination and application of the purchase tag to a user account, user Bob purchased cat food from Petco®. The marketing engine 308 can determine that cat food typically lasts 1 month; therefore a timing window can be applied to the purchase tag. That is, the purchase tag, which includes the information indicating that Bob purchased cat food on Nov. 15, 2014 from Petco®, is only active from 30 days from Nov. 15, 2014, and will expire at such time. Indeed, embodiments exist where the purchase tag window's time period can be determined based on the category determination of the purchased item in addition to a variety of factors as discussed above. As discussed in more detail below, the purchase tag time window can dictate the time period for which a user is not served ads from the same vendor for the same item purchased. When the time window expires, the user will be able to receive ads from the same vendor for the same product, as it can be determined that it may be time for the user to purchase such item (or a similar item) again.

According to some embodiments, the determination of the purchase time window can be based upon any known or to be known machine learning, pattern recognition, data mining or knowledge discovery in databases (KDD) algorithms or techniques, such as, but not limited to, Sparse Factor Analysis (SFA), Hidden Markov Models (HMMs), Support Vector Machines (SVMs), Bayesian Methods, and the like, in order to determine the ideal purchase window associated with each item (or category).

Process 400 then turns to Step 408 where an ad platform is searched, or a query is sent to cause the ad platform to search for and identify relevant ads to be served to the user. That is, Step 408 involves the initiation of a search of an ad platform for advertisements related to the user. Step 408 is performed by the search module 314 of the marketing engine 308. As discussed above, the ad platform comprises an ad server 130 and an associated ad database. In some embodiments, as discussed below in relation to Steps 408-420, an ad platform can be communicated with and instructed by a messaging server to search for advertisements (based on the applied tag/filter rule). In some embodiments, the messaging server from which the purchase information is derived, e.g., Yahoo!® Mail, can host or have an associated ad platform connected therewith. Thus, the messaging server can perform the searching, selection and serving of advertisements. In such embodiments, the messaging server has direct access to advertisements without having to outsource to third parties. For example, the messaging server has an associated databased of sponsored content provided by premium vendors. As discussed above in relation to FIG. 3, the prediction engine 308 can be hosted by a web server, content provider, email service provider, ad server, a user's computing device, or any combination thereof. Therefore, Steps 408-420 may be performed by any such device, or combination thereof.

The initiation of the search, for which an ad platform is accessed as in Step 408, involves the determination as to whether the search to be performed is associated with the purchase information (from Step 406). Step 410. That is, a determination is made regarding whether the promotional information is to be filtered out in connection with the purchase information or whether the search is to be based on the purchase information, but for different vendor information comprising promotions for the item at a lower price. Such determination can be based on the purchase tag applied to a user's information, as discussed above. The determination occurring in Step 410 is performed by the determination module 316 of the marketing engine 308.

When the determination of Step 410 results in the search to be performed with respect to the purchase information (in compliance with the time window), then the search is performed, however, the search is deferential to a filter that filters out advertisements related to the item and vendor identified in the purchase information. Step 412. That is, the ad platform is searched for advertisements while filtering out the ads associated with the vendor for the same or similar items (or items in the same category). Step 412 is performed by the filter module 318 of the marketing module 308. In some embodiments, for example, the search can be based on a Boolean Logic search query, where the purchase information in the query is separated from the rest of the ad query by a “NOT” and the item information and vendor information are connected by an “AND.”

By way of a non-limiting example, using the example above where Bob purchased cat food on Nov. 15, 2014 from Petco®, a search for an advertisement to serve Bob includes indicators to avoid sending him ads for cat food from Petco®. For example, the search query being used can include a character string as follows: pets NOT (“cat food” AND “Petco”). This search provides that ads for pet products are to be located in the ad database, but such pet products can not include cat food from Petco®. Or, all pet ads can be excluded. Furthermore, for example, since the timing window was determined to be for 30 days, ad searches in connection with serving Bob ads will continue to be based upon the purchase tag associated with Bob for 30 days. When the purchase tag expires, Bob can then be served ads for cat food from Petco®.

In some embodiments, a search for ads can be filtered out according to an item, as discussed above, and in some embodiments, an ad search can filter out an entire category of products/services offered by the same vendor, where such products/services fall within the same category as the item purchased. In some embodiments, the search may only filter out the specific item from a vendor, whereby ads related to other items from the vendor falling within the same category may be served to the user.

In Step 414, as a result of the filtered search performed in Step 412, a contextually relevant ad is selected. In Step 420, as discussed in more detail below, the selected ad can be served to the user.

Turning back to Step 410, another determination can be made that results in a search for ads being conducted also in accordance with the purchase information, but such search is for competitor's items (or similar items) that match the purchased item. Step 416. In other words, Step 416 involves searching for advertisements to identify ads from different vendors for the same item the user recently purchased (or the item identified in the purchase information or identified by the purchase tag associated with the user). In some embodiments, for example, the search can be based on a Boolean Logic search query, where the item information forms the basis of the search query, but the vendor information (the seller that sold the item) is separated from the query by a “NOT.” According to some embodiments, the search in Step 416 is for items that are being offered at a lower price than the price the user already paid for the item he/she purchased. In some embodiments, the search in Step 416 can be for items that are being offered at a price equal to or higher than the purchase price. In some embodiments, the equal to or higher price requirement can be implemented when (or if) the sourcing vendor is determined to be a trusted or preferred vendor. The search performed in Step 416 can be programmed to also be deferential to the timing window, as discussed above. Thus, in Step 418 an advertisement(s) is selected based on the search performed in Step 416, and as a result, the selected ad is served to the user, as in Step 420 discussed below.

By way of a non-limiting example, using the example above, Bob purchased cat food on Nov. 15, 2014 from Petco® for $20.00. A search for an advertisement to serve Bob would include a query for cat food from any vendor that is not Petco®. For example, the search query can include the character string as follows: “cat food” NOT “Petco”. This search involves searching for vendors selling cat food, but the search filters out searching for Petco's cat food products. Additionally, this search is searching for alternative vendor's selling cat food at a lower price. Thus, the search can include a character string as follows: “cat food” NOT “Petco” AND “less than $20.00”. As in the above example, since the timing window was determined to be for 30 days, ad searches in connection with serving Bob ads will continue to be based upon the purchase tag associated with Bob for 30 days. When the purchase tag expires, Bob can then be served ads for cat food from Petco®.

By way of another non-limiting example, using the example above, the search can be for an advertisement to serve Bob that includes a query for cat food from a trusted/preferred vendor. As discussed above, this search can be based on the trusted vendor's price being below the purchase price, or equal to or above the purchase price. For example, using the example where the trusted vendor is searched for ads having a purchase price at or above the purchase price, the search can include a character string as follows: “cat food” NOT “Petco” AND (“less than $20.00” OR (PREFERRED_OVER “Petco” AND “<110% of Purchase Price”)). This enables ads to be served from vendors that are trusted or preferred (or that have a relationship or partnership with the providing service) even if the vendors prices are equal to or slightly higher than the user's purchase price for the identical item.

The ad search and selection occurring in Steps 416-418 provides the user with opportunities to receive a competitor's promotional information for the same or similar product, enabling the user the opportunity to return the item previously purchased and purchase the item at a lower price.

According to some embodiments, the advanced searching provided in Steps 416-418 (and in Steps 412-414) can be sold to third parties, such as premium vendors or other types of content providers or advertisers. Such ad searching, as discussed herein, can be implemented for serving ads while a user browses the internet, or upon tracking a user's position via user tracking programs (e.g., Foursquare®). The disclosed search information and capabilities can enable the hosting provider from which the purchase history is derived, for example, Yahoo!®, to charge a higher premium for enabling third parties to serve ads on their system as the contextual relevance of a served ad is increased due to the avoidance of duplicative and wasteful advertisements.

As discussed above, the combination of the marketing engine 308's recognition of purchased items and searches filtering out such items and/or the items' vendors can effectuate higher click-through-rates (CTRs) and increased revenues, salience and relevance of served advertisements due to an increased confidence that the ads being served to users are not only contextually relevant to their desires, but also temporally relevant to their needs at that moment when the ads are served. This can thereby impact an advertiser's, whether a third party or hosting provider, CPM, CPC, or CPA, or under some other agreed upon billable event.

Turning back to Process 400, Step 420 involves the selected advertisement (from Step 414 and/or 418, which can occur separately or in concert when a display page comprises dynamic advertising capabilities and/or has multiple ad space) is served to the user, as discussed above. In some embodiments, as in Step 420, the selected advertisement is shared or communicated via the email platform. In some alternative embodiments, the selected advertisement is sent directly to each user's computing device. In some embodiments, the advertisement is displayed in conjunction with a message associated with a similar purchase appearing in the user's inbox. In some embodiments, the ad can be displayed as a user traverses web pages on the Internet. In some embodiments, the advertisement can be served to the user on a landing page associated with a service provider's home page (e.g., Yahoo!® Home page), in a toolbar or pane associated with a browser displaying web content, or as other types of messages such as SMS, MMS or according to any other known or to be known messaging applications, and the like, as understood by those of skill in the art.

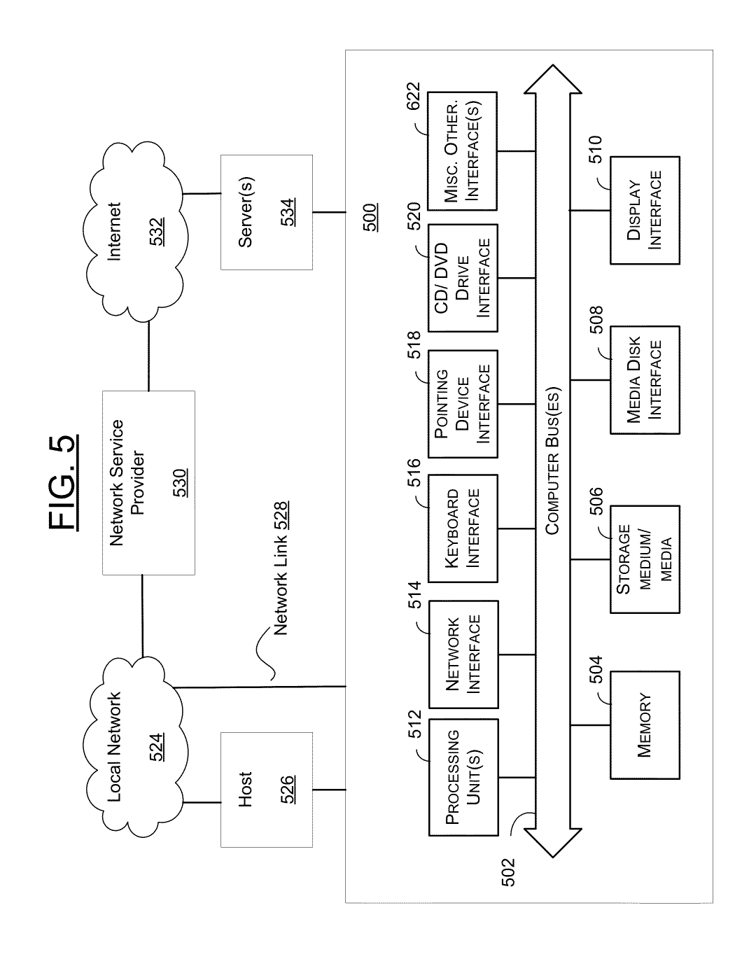

As shown in FIG. 5, internal architecture 500 includes one or more processing units, processors, or processing cores, (also referred to herein as CPUs) 512, which interface with at least one computer bus 502. Also interfacing with computer bus 502 are computer-readable medium, or media, 505, network interface 514, memory 504, e.g., random access memory (RAM), run-time transient memory, read only memory (ROM), media disk drive interface 520 as an interface for a drive that can read and/or write to media including removable media such as floppy, CD-ROM, DVD, media, display interface 510 as interface for a monitor or other display device, keyboard interface 516 as interface for a keyboard, pointing device interface 518 as an interface for a mouse or other pointing device, and miscellaneous other interfaces not shown individually, such as parallel and serial port interfaces and a universal serial bus (USB) interface.

Memory 504 interfaces with computer bus 502 so as to provide information stored in memory 504 to CPU 512 during execution of software programs such as an operating system, application programs, device drivers, and software modules that comprise program code, and/or computer executable process steps, incorporating functionality described herein, e.g., one or more of process flows described herein. CPU 512 first loads computer executable process steps from storage, e.g., memory 504, computer readable storage medium/media 506, removable media drive, and/or other storage device. CPU 512 can then execute the stored process steps in order to execute the loaded computer-executable process steps. Stored data, e.g., data stored by a storage device, can be accessed by CPU 512 during the execution of computer-executable process steps.

Persistent storage, e.g., medium/media 506, can be used to store an operating system and one or more application programs. Persistent storage can also be used to store device drivers, such as one or more of a digital camera driver, monitor driver, printer driver, scanner driver, or other device drivers, web pages, content files, playlists and other files. Persistent storage can further include program modules and data files used to implement one or more embodiments of the present disclosure, e.g., listing selection module(s), targeting information collection module(s), and listing notification module(s), the functionality and use of which in the implementation of the present disclosure are discussed in detail herein.

Network link 528 typically provides information communication using transmission media through one or more networks to other devices that use or process the information. For example, network link 528 may provide a connection through local network 524 to a host computer 526 or to equipment operated by a Network or Internet Service Provider (ISP) 530. ISP equipment in turn provides data communication services through the public, worldwide packet-switching communication network of networks now commonly referred to as the Internet 532.

A computer called a server host 534 connected to the Internet 532 hosts a process that provides a service in response to information received over the Internet 532. For example, server host 534 hosts a process that provides information representing video data for presentation at display 510. It is contemplated that the components of system 500 can be deployed in various configurations within other computer systems, e.g., host and server.

At least some embodiments of the present disclosure are related to the use of computer system 500 for implementing some or all of the techniques described herein. According to one embodiment, those techniques are performed by computer system 500 in response to processing unit 512 executing one or more sequences of one or more processor instructions contained in memory 504. Such instructions, also called computer instructions, software and program code, may be read into memory 504 from another computer-readable medium 506 such as storage device or network link. Execution of the sequences of instructions contained in memory 504 causes processing unit 512 to perform one or more of the method steps described herein. In alternative embodiments, hardware, such as ASIC, may be used in place of or in combination with software. Thus, embodiments of the present disclosure are not limited to any specific combination of hardware and software, unless otherwise explicitly stated herein.

The signals transmitted over network link and other networks through communications interface, carry information to and from computer system 500. Computer system 500 can send and receive information, including program code, through the networks, among others, through network link and communications interface. In an example using the Internet, a server host transmits program code for a particular application, requested by a message sent from computer, through Internet, ISP equipment, local network and communications interface. The received code may be executed by processor 502 as it is received, or may be stored in memory 504 or in storage device or other non-volatile storage for later execution, or both.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

For the purposes of this disclosure the term “user”, “subscriber” “consumer” or “customer” should be understood to refer to a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising the steps of:
accessing, via a computing device, a user inbox hosted by the computing device on a network;
analyzing, via the computing device, using an automated data mining and parsing process, messages in the inbox to identify a first message, said analyzing comprising the computing device parsing message data associated with the first message;
determining as part of said analysis, via the computing device, that at least a portion of the message data is associated with purchase information, said purchase information comprising information related to a purchased item and a vendor from which the item was purchased;
creating, via the computing device and based on said determining, a filter rule comprising instructions to filter out content related to the purchased item from the vendor;
communicating with a content platform, via the computing device over the network, to obtain a content item satisfying the filter rule; and
causing communication, via the computing device over the network, of said rule satisfying content item to said user.

2. The method of claim 1, further comprising:
creating, via the computing device, a second filter rule comprising instructions to identify content related to the purchased item from a second vendor, said second vendor being a different vendor than the vendor identified in the purchase information;
communicating with the content platform, via the computing device over the network, to obtain a second content item satisfying the second filter rule; and
causing communication, via the computing device over the network, of said second rule satisfying content item to said user.

3. The method of claim 1, wherein said parsed message data further comprises a purchase amount said user paid for the purchased item.

4. The method of claim 3, further comprising:
creating, via the computing device, a third filter rule comprising instructions to identify content related to the purchased item from the second vendor at a price below the purchase amount;
communicating with the content platform, via the computing device over the network, to obtain a third content item satisfying the third filter rule; and
causing communication, via the computing device over the network, of said third rule satisfying content item to said user.

5. The method of claim 3, further comprising:
determining that the second vendor is a trusted vendor;
creating, based on said trusted determination, a fourth filter rule comprising instructions to identify content related to the purchased item from the second vendor at a price equal to or higher than the purchase amount;
communicating with the content platform to obtain a fourth content item satisfying the fourth filter rule; and
causing communication, over the network, of said fourth rule satisfying content item to said user.

6. The method of claim 1, wherein said parsed message data further comprises a purchase date said user paid for the purchased item.

7. The method of claim 6, further comprising:
determining a time window for application of the filter rule based on said purchase date, wherein said communication with the content platform occurs during said time window.

8. The method of claim 1, wherein said content platform comprises advertisement information associated with advertisements and advertising vendors, and wherein said content item is associated with at least one advertisement of said advertisements.

9. The method of claim 1, further comprising:
applying, via the computing device, a tag to a profile of the user, said tag comprising information associated with said purchase information; and
identifying, via the computing device, a presence of said tag in association with said user, wherein said communication with the content platform occurs upon the identification of said tag presence.

10. The method of claim 1, further comprising:
determining a category of said purchased item, said category encompassing a range of items associated with said purchased item.

11. The method of claim 10, further comprising:
creating, via the computing device, a fifth filter rule comprising instructions to filter out content related to the category from the vendor;
communicating with the content platform, via the computing device over the network, to obtain a fifth content item satisfying the fifth filter rule; and
causing communication, via the computing device over the network, of said fifth rule satisfying content item to said user.

12. The method of claim 1, wherein said purchased item is a purchased product or a purchased service provided by said vendor.

13. A non-transitory computer-readable storage medium tangibly encoded with computer-executable instructions, that when executed by a processor associated with a computing device, performs a method comprising:
accessing a user inbox hosted by the computing device on a network;
analyzing using an automated data mining and parsing process, messages in the inbox to identify a first message, said analyzing comprising parsing message data associated with the first message;
determining as part of said analysis that at least a portion of the message data is associated with purchase information, said purchase information comprising information related to a purchased item and a vendor from which the item was purchased;
creating, based on said determining, a filter rule comprising instructions to filter out content related to the purchased item from the vendor;
communicating with a content platform, over the network, to obtain a content item satisfying the filter rule; and
causing communication, over the network, of said rule satisfying content item to said user.

14. The non-transitory computer-readable storage medium of claim 13, further comprising:
creating a second filter rule comprising instructions to identify content related to the purchased item from a second vendor, said second vendor being a different vendor than the vendor identified in the purchase information;
communicating with the content platform, over the network, to obtain a second content item satisfying the second filter rule; and
causing communication, over the network, of said second rule satisfying content item to said user.

15. The non-transitory computer-readable storage medium of claim 13, wherein said parsed message data further comprises a purchase amount said user paid for the purchased item.

16. The non-transitory computer-readable storage medium of claim 15, further comprising:
determining whether the second vendor is a trusted vendor;
when said second vendor is not a trusted vendor:
creating a third filter rule comprising instructions to identify content related to the purchased item from the second vendor at a price below the purchase amount;
communicating with the content platform, over the network, to obtain a third content item satisfying the third filter rule; and
causing communication, over the network, of said third rule satisfying content item to said user; and
when said second vendor is determined to be a trusted vendor:
creating, based on said trusted determination, a fourth filter rule comprising instructions to identify content related to the purchased item from the second vendor at a price equal to or higher than the purchase amount;
communicating with the content platform to obtain a fourth content item satisfying the fourth filter rule; and
causing communication, over the network, of said fourth rule satisfying content item to said user.

17. The non-transitory computer-readable storage medium of claim 13, wherein said parsed message data further comprises a purchase date said user paid for the purchased item, wherein said determination further comprises determining a time window for application of the filter rule based on said purchase date, wherein said communication with the content platform occurs during said time window.

18. The non-transitory computer-readable storage medium of claim 13, wherein said content platform comprises advertisement information associated with advertisements and advertising vendors, and wherein said content item is associated with at least one advertisement of said advertisements.

19. A system comprising:
a processor;
a non-transitory computer-readable storage medium for tangibly storing thereon program logic for execution by the processor, the program logic comprising:
access logic executed by the processor for accessing a user inbox hosted by a computing device on a network;
analysis logic executed by the processor for analyzing using an automated data mining and parsing process, messages in the inbox to identify a first message, said analyzing comprising parsing message data associated with the first message;
determination logic executed by the processor for determining as part of said analysis that at least a portion of the message data is associated with purchase information, said purchase information comprising information related to a purchased item and a vendor from which the item was purchased;
creation logic executed by the processor for creating, based on said determining, a filter rule comprising instructions to filter out content related to the purchased item from the vendor;
communication logic executed by the processor for communicating with a content platform, over the network, to obtain a content item satisfying the filter rule; and
communication logic executed by the processor for causing communication, over the network, of said rule satisfying content item to said user.

20. The system of claim 19, further comprising:
creation logic executed by the processor for creating a second filter rule comprising instructions to identify content related to the purchased item from a second vendor, said second vendor being a different vendor than the vendor identified in the purchase information;
communication logic executed by the processor for communicating with the content platform, over the network, to obtain a second content item satisfying the second filter rule; and
communication logic executed by the processor for causing communication, over the network, of said second rule satisfying content item to said user.
